(19) United States
(12) Patent Application Publication
(10) Pub. No.: US 2018/0148244 A1
(43) Pub. Date: May 31, 2018

(54) FOOD PACK SUITABLE FOR BEING COOKED BY STEAM HEATER

(71) Applicant: CHEN-YUAN LU, Taichung (TW)

(72) Inventor: CHEN-YUAN LU, Taichung (TW)

(21) Appl. No.: 15/361,392

(22) Filed: Nov. 26, 2016

(51) Int. Cl. B65D 81/34; A23L 5/10

(52) U.S. Cl. CPC B65D 81/3438; A23L 5/13; B65D 2581/3427; B65D 2581/3404; B65D 2581/3424; A23V 2002/00

(57) ABSTRACT

A food pack includes a body that includes a hole, and a steam heater is inserted into the hole and provides heat to cook the body of the food pack.

### BACKGROUND OF THE INVENTION

### 1. Fields of the Invention

The present invention relates to a food pack, and more particularly, to a food pack suitable for being cooked by using a steam heater.

### 2. Descriptions of Related Art

There are many instant food with different flavors available in the market, and the ways for cooking these instant food are different. Some instant food can be ready by adding hot water, and some are prepared by microwave stoves or small ovens. Some food has to be cooked in hot soup or water, and some are heated in ovens. Nevertheless, the flavors of the instant food gradually cannot meet consumers' needs which change quickly.

The present invention intends to provide a food pack that is able to be cooked by using a steam heater, and the food pack provides flavor and style that are different from the existed instant food.

### SUMMARY OF THE INVENTION

The present invention relates to a food pack which comprises a body and the body includes a hole so that a steam heater is inserted into the hole to heat the body.

Preferably, the hole is a through hole or a non-through hole.

Preferably, the body is noodles.

Preferably, the body includes multiple dumplings and raviolis. The dumplings and the raviolis are arranged as a ring.

Preferably, the body includes a layer on the top thereof. The layer includes frozen soup.

Preferably, the frozen soup includes vegetables, meat or sea food, spices and water.

Preferably, the body is a combination of noodles and soup, a combination of dumplings and soup, or a combination of raviolis and soup.

Preferably, the body is a combination of vegetables, meat or sea food, spices and water, wherein the water is frozen to maintain the vegetables, meat or sea food and spices therein.

Preferably, wherein a bag is provided to receive the body therein. The primary object of the present invention is to provide a food pack that includes a body with a hole, and a steam heater is inserted into the hole to heat the body. The way of preparing the food is different from the conventional ways such as using microwaves or traditional ovens.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the food pack of the present invention;

FIG. 2 shows that the food pack of the present invention is to be heated by a cooking machine;

FIG. 3A shows that the hole of the body of the food pack is a through hole;

FIG. 3B shows that the hole of the body of the food pack is a non-through hole;

FIG. 4 shows a bowl that the body of the food pack is to be put therein;

FIG. 5 shows the body of the food pack of the present invention;

FIG. 6A shows that the body of the food pack of the present invention includes dumplings;

FIG. 6B shows that the body of the food pack of the present invention includes raviolis;

FIG. 7 shows that the body of the food pack of the present invention includes vegetables, meat or sea food, spices and water, and

FIG. 8 shows that the body of the food pack of the present invention is treated into liquid form and the liquid form is poured into a container.

### DETAILED DESCRIPTION OF THE PREFERRED EMBODIMENT

Referring to FIG. 1, the food pack 100 of the present invention comprises a body 110 which has a hole 115 defined in the center thereof. A cooking machine 200 has a steam heater 210 which is inserted into the hole 115 to heat the body 110.

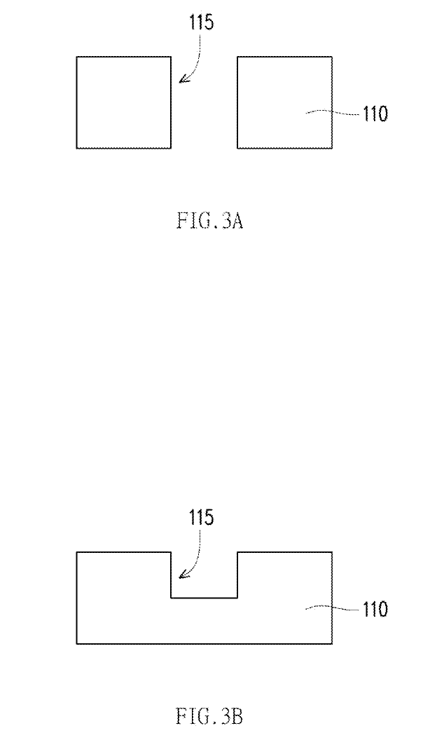

Specifically, the body 110 of the food pack 100 can be noodles which may have different types of noodles such as spaghetti, salt-flavored noodles, rice noodles and the like. The noodles are wrapped to form a desired shape during making the body 110. The hole 115 can be a through hole (FIG. 3A) or a non-through hole (FIG. 3B). For health reason, the body 110 is packed in a bag 120.

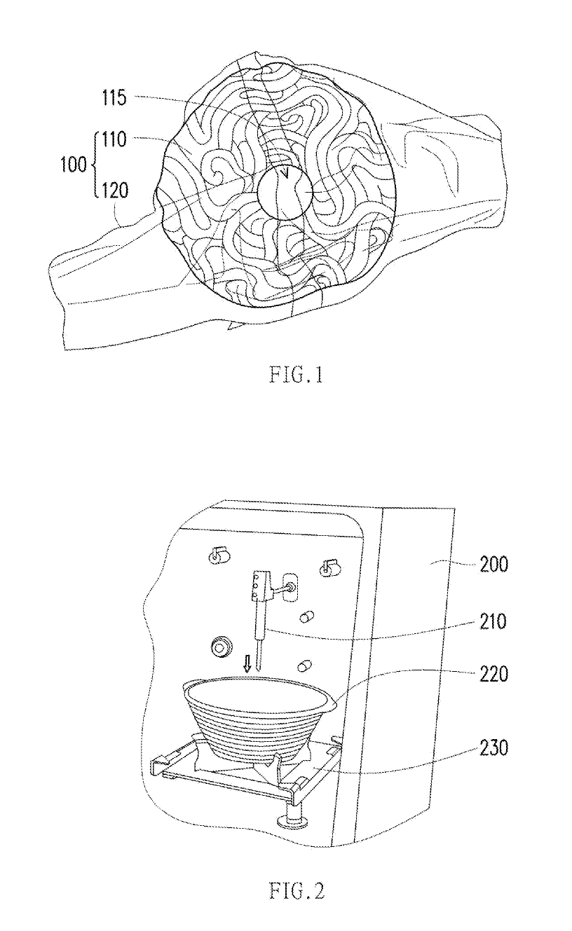

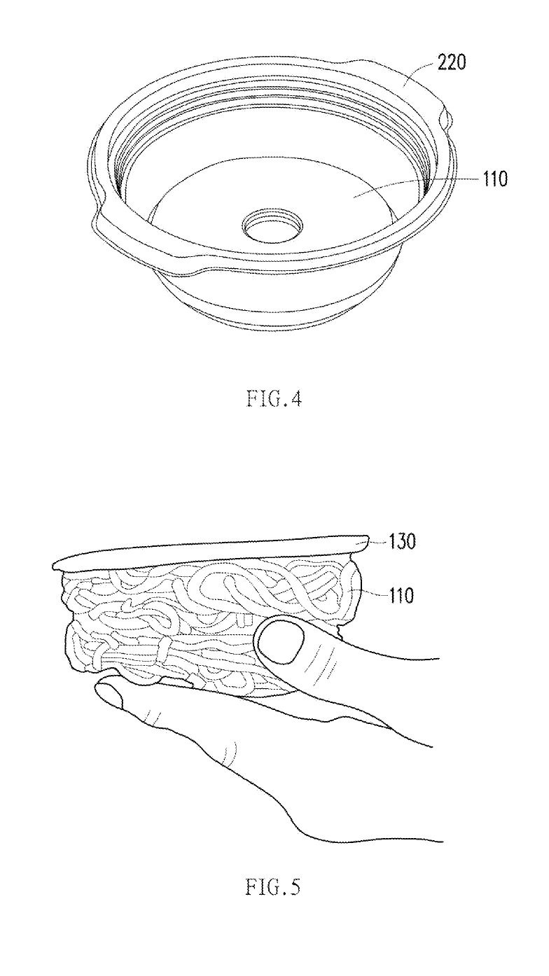

As shown in FIGS. 1, 2 and 4, when cooking the food pack 100, the bag 120 is removed and the body 110 is put in a bowl 220. The steam heater 210 is then inserted into the hole 115 of the body 110, the steam heater 210 releases steam to cook the body 110.

It is noted that after the body 110 is cooked, the bowl 220 is removed from the cooking machine 200 and the soup is put into the bowl 220. The soup 130 is a combination of vegetables, meat or sea food, spices and water. For example, the soup may include one of the vegetables, meat and sea food, and spice and water. The ratio or ingredients can be varied according to needs. The soup can be prepared and stored in a tank located in the cooking machine 200 or outside of the cooking machine 200.

FIG. 5 shows that soup and the body 110 are packed in one bag 120 for convenience of transportation and stored. Specifically, the body 110 includes a layer on the top thereof, and the layer includes frozen soup 130. The frozen soup 130 includes vegetables, meat or sea food, spices and water. The combination of the frozen soup 130 and the body 110 is then heated by using the steam heater 210.

The combination of the frozen soup 130 and the body 110 is then put in the bowl 220 and heated by using the steam heater 210. The steam heats the frozen soup 130 and the body 110. The vegetables, meat and/or sea food can be raw, in this case, the time for operation of the steam heater 210 has to be prolonged. The exact time for cooking can be tested and calculated, and the data of cooking time is stored in a data base. The time of operation of the steam heater 210 can be controlled manually or by operation to buttons of the cooking machine 200.

In another embodiment, the frozen soup 130 can be made to have the hole 115 as the body 110, so that when the frozen soup 130 is put on the body 110 in the bowl 220, the steam heater 210 is inserted into the two respective holes 115 of the frozen soup 130 and the body 110 to cook the soup 220 and the body 110. The flavor of the soup 130 is merged into the body 110 to provide better flavor to the ingredients.

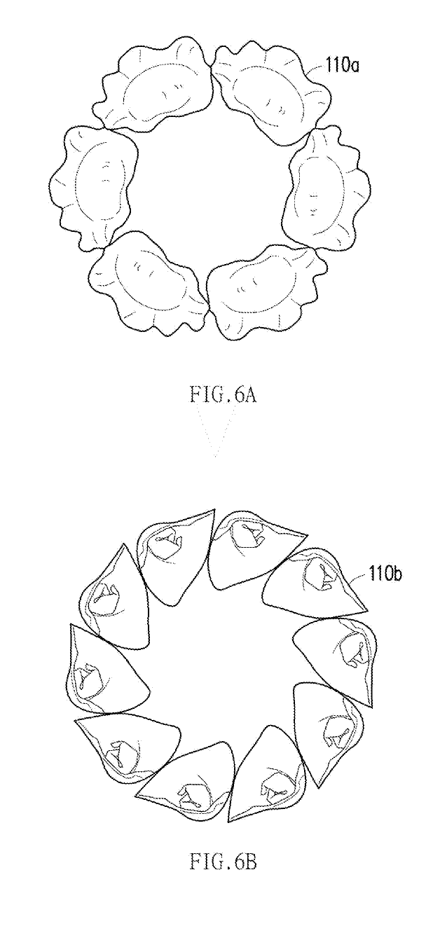

FIGS. 6A and 6B, the body 110 includes multiple dumplings 110a and raviolis 110b, the dumplings 110a and the raviolis 110b are arranged as a ring. Other block like food can also be used to replace or to be cooperated with the dumplings 110a and the raviolis 110b. The shape can also be any shape other than a ring. The dumplings 110a and the raviolis 110b may be cooked before packed. Of course, the dumplings 110a and the raviolis 110b may also be un-cooked. In order to arrange the dumplings 110a and the raviolis 110b to be a ring, the two ends of each of the dumplings 110a and the raviolis 110b can be made to be a little bit longer so as to be connect the dumplings 110a and the raviolis 110b continuously.

When cooking the dumplings 110a and the raviolis 110b by using the steam heater 210, no other utensil such as chop sticks or spoons so as to prevent the dumplings 110a and the raviolis 110b from being broken during cooking.

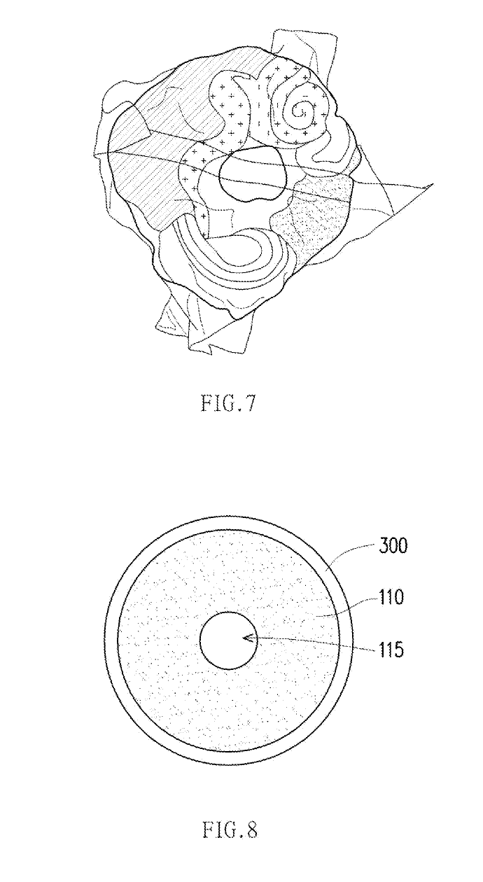

FIG. 7 shows that the body 110 is a combination of vegetables, meat or sea food, spices and water. The vegetables, meat or sea food, spices and water are cooked to be a soup with ingredients. The soup and ingredients are then poured into a container 300 to form the body 110 with the hole 115 defined centrally therethrough. As shown in FIG. 8, the frozen soup maintains the vegetables, meat or sea food and spices therein. Similarly, the combination of the soup 130 and the dumplings 110a, the soup 130 and the raviolis 110b, or the soup 130 and the noodles can also be made in the same way as mentioned above to form the body 110.

While we have shown and described the embodiment in accordance with the present invention, it should be clear to those skilled in the art that further embodiments may be made without departing from the scope of the present invention.

What is claimed is:

1. A food pack comprising:
a body which includes a hole which is adapted to receive a steam heater therein to heat the body.

2. The food pack as claimed in claim 1, wherein the hole is a through hole or a non-through hole.

3. The food pack as claimed in claim 1, wherein the body is noodles.

4. The food pack as claimed in claim 1, wherein the body includes multiple dumplings and raviolis, the dumplings and the raviolis are arranged as a ring.

5. The food pack as claimed in claim 1, wherein the body includes a layer on a top thereof, the layer includes frozen soup.

6. The food pack as claimed in claim 5, wherein the frozen soup includes vegetables, meat or sea food, spices and water.

7. The food pack as claimed in claim 1, wherein the body is a combination of noodles and soup, a combination of dumplings and soup, or a combination of raviolis and soup.

8. The food pack as claimed in claim 1, wherein the body is a combination of vegetables, meat or sea food, spices and water, the water is frozen to maintain the vegetables, meat or sea food and spices therein.

9. The food pack as claimed in claim 1 further comprising a bag in which the body is received.
